(19) United States
(12) Patent Application Publication
(10) Pub. No.: US 2011/0158595 A1
(43) Pub. Date: Jun. 30, 2011

(54) RARE-EARTH-DOPED FIBER OPTIC WAVEGUIDE AND OPTICAL DEVICE COMPRISING IT

(75) Inventors: Ekaterina Burov, Boulogne-Billancourt (FR); Alain Pastouret, Massy (FR); Christian Simonneau, Nozay (FR); Laurent Gasca, Villebon-Sur-Yvette (FR); Christine Collet, Mennecy (FR)

(73) Assignee: Alcatel Lucent, Paris (FR)

(21) Appl. No.: 12/735,569

(22) PCT Filed: Jan. 27, 2009
(86) PCT No.: PCT/FR2009/050115

§ 371 Date: Feb. 14, 2011

(30) Foreign Application Priority Data
Feb. 1, 2008 (FR) 0850650

(51) Int. Cl. G02B 6/02; H01S 3/067; B82Y 20/00

(52) U.S. Cl. 385/123; 359/341.3; 264/1.24; 977/773

(57) ABSTRACT

The invention relates to an optical waveguide, in particular an optical fibre comprising a core, formed from a material based on rare-earth-ion-doped silica, covered by an optical cladding. Nanoparticles, at least some of which are metal nanoparticles, are dispersed in the material of the core. The optical devices, such as especially optical amplifiers, comprise an optical fibre having a core formed, from a material based on rare-earth-ion-doped silica covered with an optical cladding, nanoparticles, at least some of which are metal nanoparticles, being dispersed in the material of the core, and a pumping source delivering electromagnetic excitation radiation, which propagates in the core.

The present invention pertains to a rare-earth-ion-doped optical waveguide of the sort used in optical devices such as optical amplifiers. Furthermore, it extends to optical devices comprising such a guide, and to the method for manufacturing that guide.

Optical amplification relies on the phenomenon of stimulated emission: the signal is amplified within a waveguide due to an outside addition of energy known as pumping. Some optical amplifiers comprise a waveguide doped with rare-Earth ions (lanthanide families such as Pr, Tb, Yb or Er) constituting the amplifying medium, associated with a source of optical pumping and a multiplexer for coupling the light flow coming from the pumping source to the signal within the waveguide.

Amplifiers, particularly comprising an erbium Er³⁴-doped fiber (EDF for “Erbium Doped Fiber”) are currently used in ail optical transport systems for localized amplification of an optical signal. They represent the best current solution for amplifying a multiplexed signal. In order to achieve good performance, one of the restrictions to comply with when designing these amplifiers is that the pumping waveguides be strictly limited to a well-defined wavelength, i.e. 978 nm±5 nm or 1480 nm ±5 nm. Consequently, the choice of the pumping source is limited to a specific and very costly technology, which is high-power pump laser diodes using semiconductors. Furthermore, in some applications in which high power is not necessary (an EDFA amplifier and a single wavelength placed before the receiver with which it is associated, for example), it may be extremely helpful to be capable of sending a pump signal using a very low-cost source, such as a light-emitting diode (LED), for example, which is not possible with known doped optical guides.

Currently, in erbium-doped fiber amplifiers (EDFAs), a solution is not used which would make it possible to send a pump signal with a wavelength different from the previously mentioned values of 980 nm or 1480 nm.

A known method to succeed in using a different wavelength is to use energy transfer via a co-doping agent with a large absorption cross-section and which is capable of transferring its energy in a non-radiative manner to erbium (ytterbium/erbium transfer or semiconductor/erbium transfer). The pump's beam is absorbed by the co-doping agent (donor ion), which is excited at a higher energy level, the energy is then transferred to the erbium (receiving ion) which causes the transition.

This method allows absorption and emission to become uncoupled from one another, making it possible to expand the choice of the pumped wavelengths and the modification of the effective absorption cross-section.

However, this method exhibits several drawbacks. First, when transferring energy using the ytterbium/erbium pair, amplification over the entire C band (1529 nm to 1565 nm) is not possible because the band's amplification begins at 1535 nm, and additionally, does not lead to an actual change in the pumping wavelength, because variation is only possible in the range of 915 to 1000 nm. Furthermore, the semiconductor/erbium transfer suffers from the difficulty of keeping the semiconductors' atoms in their reduced state. Furthermore, in all situations, the transfer is limited to the co-doping agent placed in the vicinity of the erbium.

The purpose of the present invention is to offer a solution that makes it possible to adapt the pumping wavelengths in order to be able to send a pump signal at the desired wavelength within a device comprising a rare earth doped-waveguide.

A further purpose of the invention is to enable pumping at different wavelengths from those that are normally used: 978 nm±15 nm or around 1480 nm (1450 nm to 1510 nm).

A further purpose of the invention is to enable the use of varied, low-cost pumping sources.

The object of the present invention is an optical waveguide, in particular an optical fiber comprising a core, formed of a material based on rare earth ion-doped silica, an optical cladding covering the core, and nanoparticles. at least partially made of metal, being dispersed within the core's material.

According to one particular form of the invention's authentication, the size of the nanoparticles is roughly smaller than the wavelength of the electromagnetic excitation radiation, meaning the pump's signal. Advantageously, the nanoparticles have a size less than or equal to 20 nm.

An optical fiber used to constitute an amplifier or laser conventionally comprises an amplifying medium comprising:
a core made of a matrix of transparent material in which are added active doping elements which are the site of the amplification phenomenon, such as rare earth ions including erbium, and
an optical cladding for guiding the light power, most of which is transmitted by the core.

The inventive optical fiber makes it possible to use the phenomena of surface plasmonic resonance (SPR), which is generated in the vicinity of the nanoparticles containing metal under the effect of the pump. This phenomena results from the resonant interaction between electromagnetic radiation and free electrons located at the interface between the metal and the dielectric matrix, which generates an electron density wave known as localized surface plasmon (LSP).

The stimulated emission of erbium is optimized by adapting the SPR wave's conditions of compatibility with the erbium absorption band. The intensity, wavelength and decay distance of the surface plasmonic resonance (SPR) are heavily dependent on the nature of the nanoparticles, their size, and their shape, as well of the composition of the dielectric matrix in which they are dispersed. The dielectric matrix may particularly be based on silica, a polymer, and/or primarily contain bismuth, fluorine, or aluminum. It may furthermore contain one or more doping agents.

Given that, in this situation, the energy transfer mechanism is different from direct YB/Er or semiconductor/Er transfers, the effectiveness of the coupling does not make it necessary that the nanoparticles are dispersed in the immediate vicinity of the erbium as in the prior art. The nanoparticles may produce their effect up to a distance of 10 to 15 nm from the erbium ion.

According to the invention, the nanoparticles and the rare earth ions are distributed within the same zone, meaning in the core. Nanoparticles may potentially be found within a very thin area adjacent to the core, provided that its thickness is less than or equal to 15 μm.

Metals capable of generating an SPR compatible with the telecom bands and the restrictions related to manufacturing the optical guide are chosen based on the following main criteria.
the metal's melting point must be higher than the temperature applied during the manufacturing of the guide,
a high density of electrons is important for the effectiveness of the SPR
the metal must have good oxidation resistance,
the optical properties must be compatible with the propagation conditions in the guide (distribution of losses, refraction index, etc.).

According to one embodiment of the invention, the nanoparticles contain at least one metal chosen from among gold (Au), silver (Ag), rhodium (Rh), iridium (Ir), ruthenium (Ru), molybdenum (Mo), and osmium (Os). This list is not exhaustive. The presence of plasmons on the surface of these metals may be detected by optical special analysis.

The nanoparticles may be covered with a layer of dielectric material, which facilitates their dispersion and protects them from oxidation. Advantageously, this layer may possess a high dielectric constant modifying the characteristics of the surface plasmonic resonance (SPR).

According to a first embodiment of the invention, the nanoparticles are made of metal.

According to a second embodiment of the invention, the nanoparticles are made of a metal core whose surface is at least partially covered with a layer containing rare earth ions.

According to a third embodiment of the invention, the nanoparticles are formed of a core containing rare earth ions whose surface is at least partially covered with a layer of metal.

A further object of the invention is an optical device comprising an optical fiber comprising a core formed of the material based on rare earth ion-doped silica covered with an optical cladding, nanoparticles, at least partially made of metal, being dispersed within the core's material, and a source of pumping delivering electromagnetic excitation radiation propagating into the core.

A further object of the invention is an optical amplifier comprising an optical fiber comprising a core formed of a material based on rare earth ion-doped silica covered With an optical cladding, nanoparticles, at least partially made of metal, being dispersed within the core's material, and a pumping source delivering electromagnetic excitation radiation propagating into the core.

The invention has the advantage of allowing the production of lower-cost EDFA amplifiers owing to the possibility of using a different pumping wavelengths. A further advantage of the invention is the polyvalent of the optical fiber used to exploit this phenomenon, thereby opening the way to numerous applications.

According to one particular embodiment, nanoparticles that are at least partially made of metal are suspended in a solution containing rare earth ions.

A further object of the invention is a method for manufacturing an optical fiber comprising the following steps:
rare earth ions are placed in a solution,
nanoparticles which are at least partially made of metal are suspended in the solution,
the nanoparticles are incorporated into the core material of a preform, or in its immediate vicinity,
a waveguide is produced from the preform.

The invention has a genuine interest for all competitors who need the availability of less expensive components and optical networks, particularly for telecommunications applications. The proposed solution may also find applications in other fields than telecommunications, such as fiber lasers, in view of industrial and medical applications.

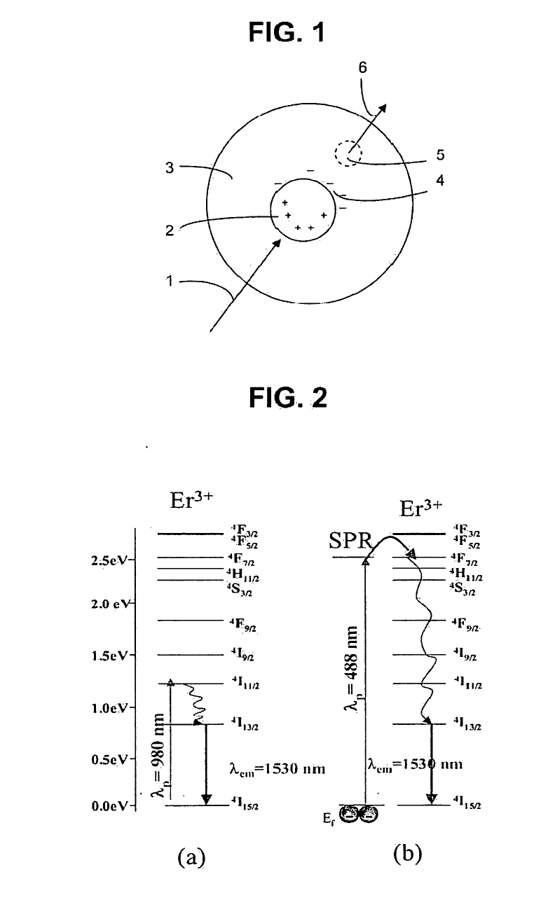

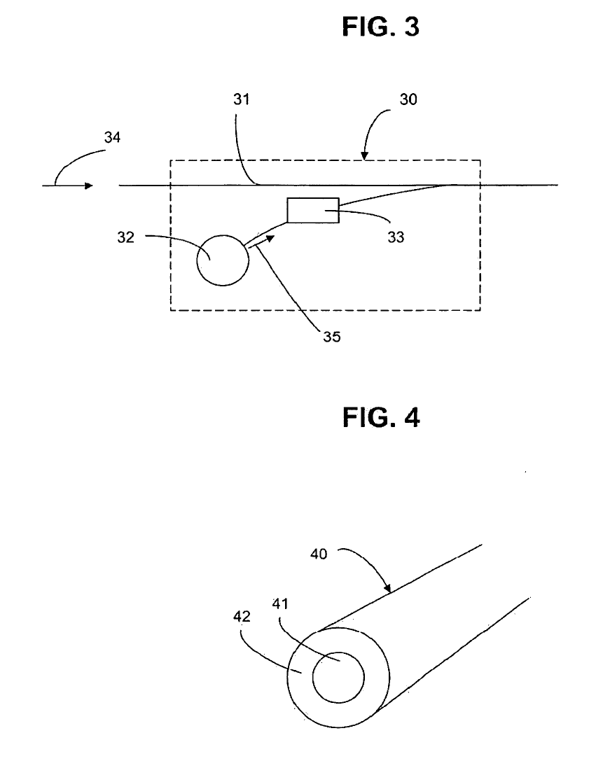

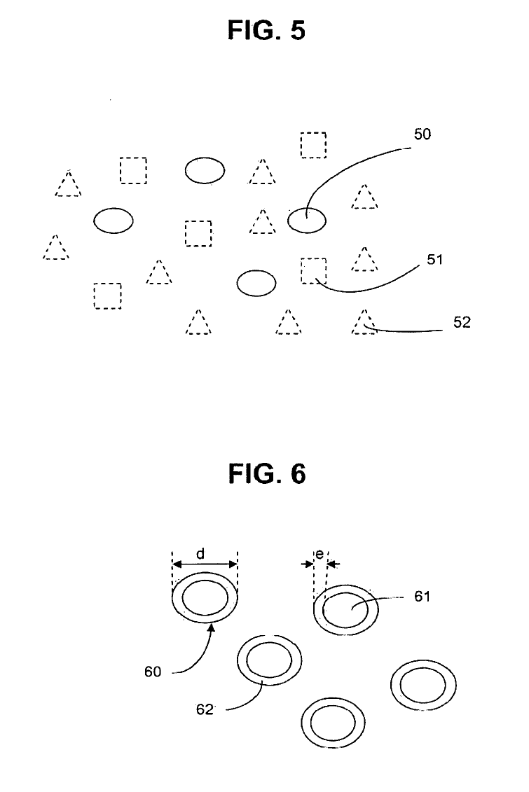

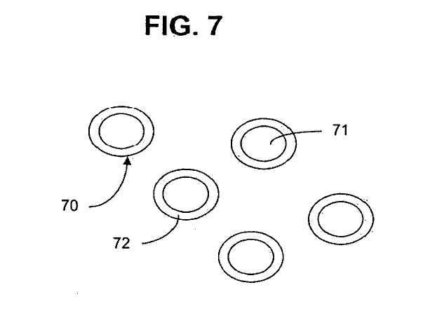

Other characteristics and advantages of the present invention will become apparent upon reading the following description of one embodiment, which is naturally given by way of a non-limiting example, and in the attached drawing, in which:
FIG. 1 is a diagram illustrating the phenomenon of surface plasmonic resonance (SPR),
FIGS. 2a and 2b illustrate transitions of the erbium ion occurring in the absence arid presence of the phenomenon of surface plasmonic resonance (SPR),
FIG. 3 schematically depicts an optical device according to one embodiment of the invention.
FIG. 4 schematically depicts an optical guide according to one embodiment of the invention.
FIG. 5 depicts a first embodiment of the invention,
FIG. 6 depicts a second embodiment of the invention,
FIG. 7 depicts a third embodiment of the invention,

FIG. 1 depicts an electromagnetic excitation wave 1 emitted by the pump laser. The wave 1 causes a plasmonic resonance effect on the surface of a nanoparticle 2 that is at least partially made of metal, contained within the material 3 of the optical, fiber's core, which causes the oscillation of the electronic surface cloud 4. The erbium ion 5 placed in the vicinity of the metallic nanoparticle 2 is excited, and emits a photon 6 as it becomes de-excited.

FIG. 2a shows the energy levels of the erbium ions incorporated into a matrix, the majority of which is made of silica. The level ⁴l_{15/2} depicts the fundamental level. The level ⁴l_{13/2} is subdivided into sub-levels (not depicted in the figure) and corresponds to a light emission/absorption zone between 1450 nm and 1620 nm. Conventional pump diodes are used which emit around 1480 nm to excite the erbium ions.

The level ⁴l_{11/2} corresponds to an absorption area around 978 nm. Unlike level ⁴l_{13/2}, this is a nearly non-radiating level. Conventional pump diodes are used which emit around 978 nm to excite, the erbium ions.

For amplification around 1550 nm, the other levels of energy depicted possess very low effectiveness. For example, the level ⁴F_{7/2} enables a very low absorption at the wavelength of 488 nm.

FIG. 2b depicts these Same levels of erbium ion energies, as well as an example energy level of a resonant surface plasmon (SPR) of a metallic nanoparticle. This nanoparticle exhibits high absorption around 488 nm. The proximity of this metallic nanoparticle with an erbium ion will enable the transfer of the energy absorbed by the metallic nanoparticle to the erbium ion. Unlike traditional co-doping agents, such as ytterbium, in which the proximity between the Er³⁺ ion and the co-doping agent must be less than 2 nm; in the situation of a nanoparticle which is at least partially made of metal, this proximity may extend to 10 nm.

An optical device according to one embodiment of the invention is depicted in FIG. 3. The device 30 is here an optical amplifier. It comprises a waveguide such as an optical fiber 31 and a pumping source 32 which may be a light-emitting diode (LED), for example. Normally, a multiplexer 33 is associated with the pumping source 32. An incident signal 34 travels down the optical fiber 31 and is amplified by means of the pump wave 33 sent by the source 32 within the optical fiber 31.

The waveguide depicted in FIG. 4 is an optical fiber 40 comprising at least one core 41 coaxially surrounded by an optical cladding 42. The core and the cladding are normally made of a silica-based glass material. The exterior of the optical fiber is normally also covered with a protective polymer coating. A conventional method for doping an optical fiber is impregnating the porous material of the core with an aqueous or alcoholic solution containing the doping agents. In the situation of a rare earth ion-doped optical fiber, the material of the core may be made of an erbium-doped alumino-silicate, for example.

The following examples illustrate a few of the embodiments of the inventive solution. The production of optical fibers particularly uses a modified chemical vapor deposition (MCVD) method.

FIG. 5 depicts the situation in which metallic nanoparticles whose plasmonic resonance in the visible spectrum is around 488 nm, the absorption band of erbium, are added into the optical fiber. The SPR wavelength position may be modified by varying the size of the nanoparticles through altering the manufacturing parameters.

In the present example, metal nanoparticles 50 are incorporated into the silica-based glass material 51 of an optical fiber's core. The metal nanoparticles are obtained in an aqueous dispersion through physical methods and rely on soft chemistry. The erbium 52 and aluminum 53 ions are mixed by the simultaneous dissolution of ErCl₃ and AlCl₃ chlorides in water. The nanoparticles 50 are then added into the solution containing the rare earth ions. All the additives (Er, Al, nanoparticles) are then incorporated into the core material at the same time in order to form a doped optical preform, which is finally fibered in order to give an optical fiber.

The addition of these nanoparticles makes it possible to increase by more than tenfold, compared to pumping the Er³⁺ ion, the effectiveness of pumping at 488 nm, by using, for example, a light emitting diode (LED), and therefore allows the use of low-cost optical pumps.

In the embodiment shown in Figure 6, the optical fiber is doped with nanoparticles 60 composed of a core containing rare earth ions 61, for example a silica-based glass core containing Er/Al ions. Whose surface is at least partially coated with a layer of metal 62. In this situation, the wavelength of the SPR may be adapted to the pumping, by varying the thickness e of the layer of metal and the diameter d of the core. There is a high level of electromagnetic coupling between the interior and exterior of the interface barriers 63 of the layer of metal when the diameter d is much less than the thickness e.

For a given outside diameter d, the wavelength of the plasmon's peak excitation moves significantly from visible wavelengths to infrared wavelengths with the reduction in thickness e of the layer of metal 62. A sufficient thickness between 2 nm and 15 nm will therefore be chosen.

Cores containing rare earth ions 61 such as Er/A are synthesized physically or through soft chemistry, which makes it possible to obtain a nanometric-scale powder. The powder is then coated with a layer of metal, physically or through soft chemistry The layer of metal 62 may cover the entire surface of the cores 61 or be limited to certain areas of the surface. The nanoparticles 60 that are obtained are placed in an aqueous or alcoholic suspension, and are incorporated into the core material of a preform through impregnation. The optical fiber is then obtained by fibering the preform.

FIG. 7 shows the situation in which the optical fiber is doped with nanoparticles 70 composed of metal cores 71 which are at least partially covered with a layer containing rare earth ions 72, such as Er/Al. In this situation, adding the erbium ion into the coating of the nandparticie 70 makes it possible to control the distance between the surface of the metal and the Er³⁺ ion, making it possible to optimize the conditions of the energy transfer under the effect of pumping, and the increase of the erbium's emission value.

The metal cores 71 are synthesized through a physical method or through soft chemistry leading to the production of a nanometric-scale powder. The powder is then coated with a layer containing Er/Al 72 through physical means or soft chemistry. The layer of metal 72 may cover the entire surface of the cores 71 or be limited to certain areas of the surface. The nanoparticles 70 that are obtained are placed in an aqueous or alcoholic suspension, and are incorporated into the core material of a preform through impregnation. The optical fiber is then obtained by fibering the preform.

1. An optical fiber comprising
a core, formed of a material based on rare earth ion-doped silica,
an optical cladding covering the core,
nanoparticles, at least partially made of metal, dispersed within the core's material.

2. An optical fiber according to claim 1, wherein the size of the nanoparticles is smaller than the wavelength of the electromagnetic excitation radiation.

3. An optical fiber according to claim 2, wherein the nanoparticles have a size less than or equal to 20 nm

4. An optical fiber according to claim 1, wherein the nanoparticles contain at least one metal chosen from among gold, silver, rhodium, iridium, ruthenium, molybdenum, and osmium.

5. An optical fiber according to claim 1 , wherein the nanoparticles are made of metal.

6. An optical fiber according to claim 1, wherein the nanoparticles are formed of a metal core whose surface is at least partially coated with a layer containing rare earth ions.

7. An optical fiber according to claim 1, wherein the nanoparticles are formed of a core containing fare earth ions whose surface is at least partially covered with a layer of metal.

8. An optical fiber according to claim 1, wherein the nanoparticles are covered with a layer of dielectric material.

9. An optical device comprising an optical fiber comprising a core formed of a material based on rare earth ion-doped silica covered with an optical cladding, nanoparticles, at least partially made of metal, being dispersed within the core's material, and a pumping source delivering electromagnetic excitation radiation propagating into the core.

10. An optical, amplifer comprising an optical fiber comprising a core formed of a material based on rare earth ion-doped silica covered with an optical cladding, nanoparticles, at least partially made of metal, being dispersed within the core's material, and a source of pumping delivering electromagnetic excitation radiation propagating into the core.

11. A method for manufacturing an optical fiber, comprising a core formed of a material based on rare earth ion-doped silica covered with an optical cladding, nanoparticles that are at least partially made of metal, being dispersed in the core's material, which method comprises:
rare earth ions being placed in a solution,
nanoparticles which are at least partially made of metal being suspended in the solution,
the nanoparticles are incorporated into the core material of a preform, and
a waveguide is produced from the preform.
